(19) United States
(12) Patent Application Publication
(10) Pub. No.: US 2022/0243096 A1
(43) Pub. Date: Aug. 4, 2022

(54) ADHESIVE TAPE AND MOBILE TERMINAL

(71) Applicant: LG ELECTRONICS INC., Seoul (KR)

(72) Inventors: Jeehoon KIM, Seoul (KR); Minha LEE, Seoul (KR); Eungbong YI, Seoul (KR); Byoungyong HONG, Seoul (KR)

(73) Assignee: LG ELECTRONICS INC., Seoul (KR)

(21) Appl. No.: 17/615,698

(22) PCT Filed: Jul. 2, 2019
(86) PCT No.: PCT/KR2019/008022

§ 371 Date: Dec. 1, 2021

(51) Int. Cl. C09J 7/10; H04M 1/02; C09J 7/38; C09J 11/00; B32B 7/12; B32B 27/18; B32B 27/38; B32B 27/40; B32B 27/30; B32B 27/28

(52) U.S. Cl. CPC C09J 7/10; B32B 2307/51; C09J 7/385; C09J 11/00; B32B 7/12; B32B 27/18; B32B 27/38; B32B 27/40; B32B 27/308; B32B 27/283; C09J 2203/326; C09J 2301/408; C09J 2463/00; C09J 2433/00; C09J 2483/00; C09J 2475/00; B32B 2457/206; B32B 2307/546; B32B 2262/101; H04M 1/0268

(57) ABSTRACT

This adhesive tape is characterized by comprising: a plurality of fibers; and binding resin mixed with the plurality of fibers, wherein the fibers are arranged side-by-side in a first direction and extend longitudinally in a second direction perpendicular to the first direction. The adhesive tape stretches elastically in a horizontal direction while reliably supporting a flexible display unit, and thus can deform according to the bending deflection of the flexible display unit. Therefore, the adhesive tape can reliably maintain a coupled state with a support frame that supports the rear surface of the flexible display unit.

### TECHNICAL FIELD

The present disclosure relates to an adhesive tape that is vertically rigid and horizontally flexible and mobile terminal based on the same.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

As multimedia devices become more important, there is a need for a larger display unit. However, if the display unit is enlarged, the portability of the mobile terminal may decrease as the size thereof increases. To satisfy both of the two requirements: portability and display unit size, a flexible display may be used.

Due the flexibility of the flexible display, the flexible display may not be damaged when bent at a predetermined curvature. When the flexible display is used, the size of the mobile terminal may be reduced for portability, and the display unit may be extended to obtain information from the mobile terminal.

However, considering that the rigidity of such a flexible display is lower than that of a conventional flat plate display, materials and structures for improving the rigidity and flexibility may be required.

### DISCLOSURE

### Technical Problem

To solve the above-described problems and other problems, the present disclosure provides an adhesive tape that is vertically rigid and horizontally flexible and mobile terminal based on the same.

### Technical Solution

In an aspect of the present disclosure, an adhesive tape is provided. The adhesive tape may include: a plurality of fibers; and a binding resin having the plurality of fibers mixed therein. The fibers may be arranged side by side in a first direction and elongate in a second direction perpendicular to the first direction.

The binding resin may include at least one of epoxy, acrylic, silicone, urethane, or cyanate ester.

The adhesive tape may have flexibility in the second direction.

In another aspect of the present disclosure, a mobile terminal is provided. The mobile terminal may include: a second flexible member positioned on a rear surface of a first flexible member; and an adhesive tape configured to attach the first flexible member and the second flexible member. The adhesive tape may include: a plurality of fibers arranged side by side in a first direction and elongate in a second direction perpendicular to the first direction; and a binding resin having the plurality of fibers mixed therein.

The first flexible member may include a flexible film, and the second flexible member may include a plurality of unit frames and a connector configured to vary an angle between the unit frames.

The unit frames may be arranged side by side in the first direction and have a bar shape extending in the second direction.

The first flexible member may include a flexible display.

The binding resin may include at least one of epoxy, acrylic, silicone, urethane, or cyanate ester.

### Advantageous Effects

The mobile terminal and control method thereof according to the present disclosure have the following effects.

According to the present disclosure, an adhesive tape may stably support a flexible display and, at the same time, stretch with flexibility in the horizontal direction so that the adhesive tape may be deformed in response to the bending deformation of the flexible display. In addition, the adhesive tape may stably maintain the bonding with a support frame configured to support the rear surface of the flexible display.

Since the adhesive tape has vertical rigidity, the adhesive tape may prevent the flexible display from being damaged when pressure is applied to the flexible display.

Further scope of applicability of the present disclosure will become apparent from the detailed description given hereinafter. However, it should be understood that the detailed description and specific examples, while indicating preferred embodiments of the disclosure, are given by illustration only, since various changes and modifications within the spirit and scope of the disclosure will become apparent to those skilled in the art from this detailed description.

### DESCRIPTION OF DRAWINGS

FIG. 1A is a block diagram of a mobile terminal in accordance with the present disclosure.

FIGS. 1B and 1C are conceptual views of one example of the mobile terminal, viewed from different directions.

FIG. 2 is a view showing a folded state of the mobile terminal according to the present disclosure.

FIG. 3 is a view showing another embodiment of the mobile terminal 100 according to the present disclosure.

FIG. 4 is a view showing a flexible display unit of the mobile terminal 100 and a support structure thereof according to the present disclosure.

FIG. 5 is a view showing a layered structure of the flexible display unit of the mobile terminal according to the present disclosure.

FIG. 6 is a view showing detailed configurations of an adhesive tape according to the present disclosure.

FIG. 7 is a view showing a cross section of A-A of FIG. 6 depending on states of the adhesive tape according to the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

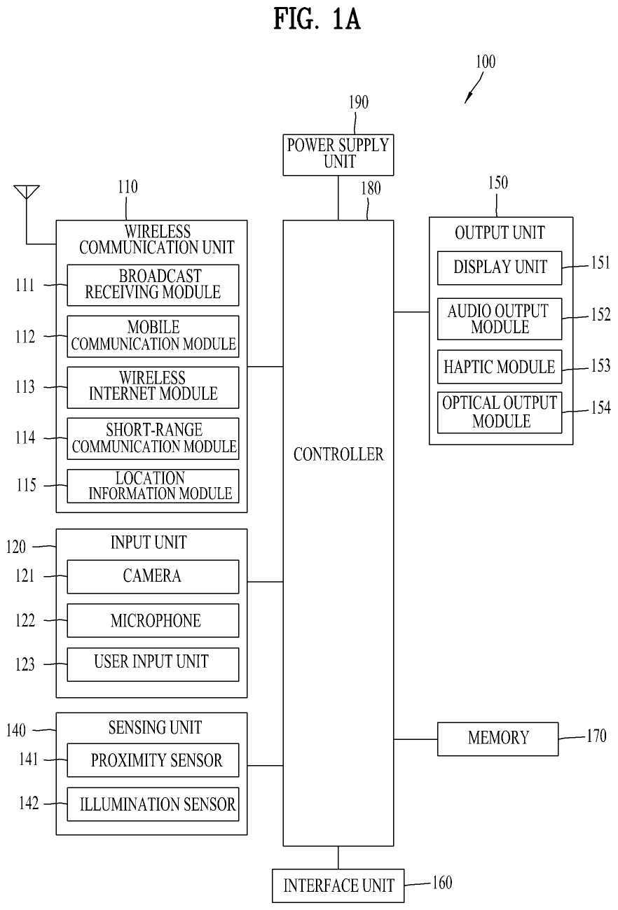

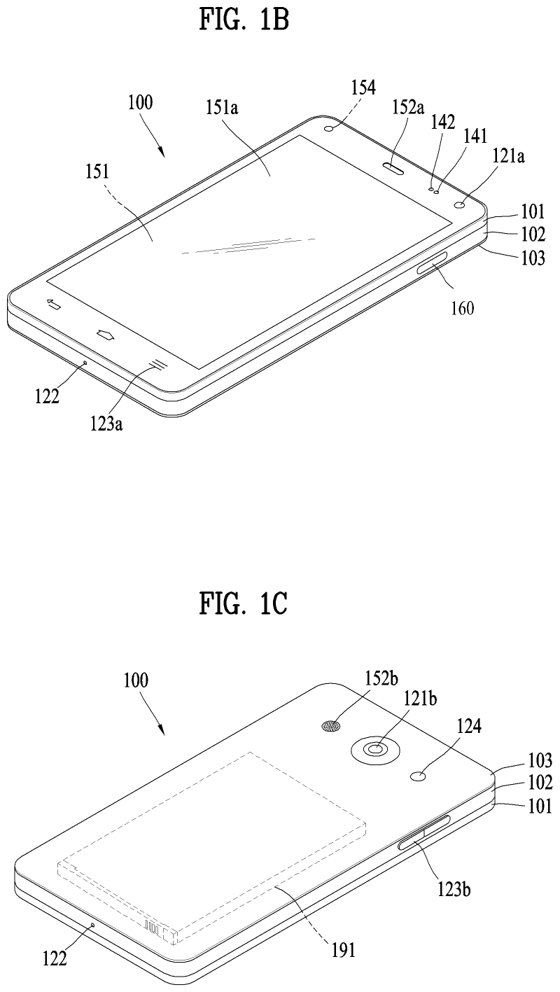

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in FIG. 1A is not a requirement, and that greater or fewer components may alternatively be implemented than the components listed above.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed as a user's control command.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to a concept referring to the mobile terminal 100 viewed as at least one assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first and second audio output modules 152a and 152b, the proximity sensor 141, the illuminance sensor 142, the optical output module 154, the first and second cameras 121a and 121b, the first and second manipulation units 123a and 123b, the microphone 122 and the interface unit 160.

It will be described for the mobile terminal as shown in FIGS. 1B and 1C. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sound

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A). may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

According to the present disclosure, information processed by the mobile terminal may be displayed on a flexible display. Hereinafter, details of the flexible display will be described in detail with reference to the accompanying drawings.

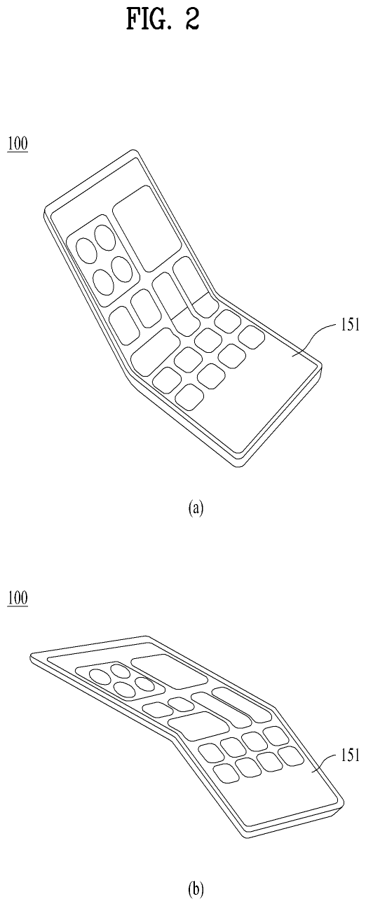

FIG. 2 is a conceptual view of a deformable mobile terminal according to an alternative embodiment of the present disclosure.

In this figure, mobile terminal 100 is shown having display unit 151, which is a type of display that is deformable by an external force. This deformation, which includes display unit 151 and other components of mobile terminal 100, may include any of curving, bending, folding, twisting, rolling, and combinations thereof. The deformable display unit 151 may also be referred to as a “flexible display unit.” In some implementations, the flexible display unit 151 may include a general flexible display, electronic paper (also known as e-paper), and combinations thereof In general, mobile terminal 100 may be configured to include features that are the same or similar to that of mobile terminal 100 of FIGS. 1A-1C.

The flexible display of mobile terminal 100 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 151 is not deformed (for example, in a state with an infinite radius of curvature and referred to as a first state), a display region of the flexible display unit 151 includes a generally flat surface. When in a state that the flexible display unit 151 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 151 may be a curved state (for example, a state of being curved from up to down or from right to left), instead of being in flat state. In this embodiment, when an external force is applied to the flexible display unit 151, the flexible display unit 151 may transition to the second state such that the flexible display unit is deformed into the flat state (or a less curved state) or into a more curved state.

If desired, the flexible display unit 151 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 100 to include a deformation sensor which senses the deforming of the flexible display unit 151. The deformation sensor may be included in the sensing unit 140.

The deformation sensor may be located in the flexible display unit 151 or the case 101 to sense information related to the deforming of the flexible display unit 151. Examples of such information related to the deforming of the flexible display unit 151 may be a deformed direction, a deformed degree, a deformed position, a deformed amount of time, an acceleration that the deformed flexible display unit 151 is restored, and the like. Other possibilities include most any type of information which can be sensed in response to the curving of the flexible display unit or sensed while the flexible display unit 151 is transitioning into, or existing in, the first and second states.

In some embodiments, controller 180 or other component can change information displayed on the flexible display unit 151, or generate a control signal for controlling a function of the mobile terminal 100, based on the information related to the deforming of the flexible display unit 151. Such information is typically sensed by the deformation sensor.

The mobile terminal 100 is shown having a case 101 for accommodating the flexible display unit 151. The case 101 can be deformable together with the flexible display unit 151, taking into account the characteristics of the flexible display unit 151.

A battery (not shown in this figure) located in the mobile terminal 100 may also be deformable in cooperation with the flexible display unit 151, taking into account the characteristic of the flexible display unit 151. One technique to implement such a battery is to use a stack and folding method of stacking battery cells.

The deformation of the flexible display unit 151 not limited to perform by an external force. For example, the flexible display unit 151 can be deformed into the second state from the first state by a user command, application command, or the like.

At least a part of the case of the mobile terminal 100 including the flexible display unit 151 may be configured to be deformable, and the flexible display unit 151 may be bent in response to the deformation of the cases 101 and 102.

When a specific part of the mobile terminal 100 is bent as shown in FIG. 2, the mobile terminal may be referred to as a foldable mobile terminal 100. Such a mobile terminal may be folded to half the size by being completely folded 180 degrees. The mobile terminal 100 may be folded inward so that the folded screens of the flexible display unit 151 face each other as shown in FIG. 2(a). Alternatively, the mobile terminal 100 may be folded outward so that the flexible display unit 151 is exposed to the outside when folded.

In this case, the flexible display unit 151 may be bent at a predetermined curvature, instead of being bent completely. Specifically, the flexible display unit 151 may be bent into a curved shape so that there is no boundary when unfolded flat again.

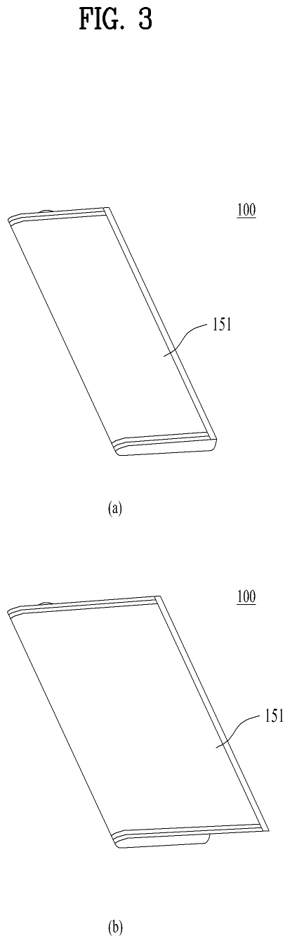

FIG. 3 is a view showing another form of the mobile terminal 100 according to the present disclosure. When the size of the body of the mobile terminal 100 is changed in the first direction, the position of a bending part of the flexible display unit 151 may vary along a roller. The mobile terminal 100 may be implemented not only in the form shown in FIG. 2 where the flexible display unit 151 is bent at a specific position but also in the form shown in FIG. 3 where the bending part of the flexible display unit 151 is variable.

At least a portion of the flexible display unit 151 of the mobile terminal 100 may change from the bending state to the flat state and vice versa. In this case, there may be an error in the radius of curvature between the flexible display unit 151 and a support frame 105 for supporting the rear surface of the flexible display unit 151.

When the curvature of a flexible member having a predetermined thickness changes, a length tolerance may be generated due to the radius of curvature difference between the inner and outer sides. For example, when the flexible display unit 151 is bent such that the folded screens face each other as shown in FIG. 2(a), the ends of the flexible display unit 151 located inside may protrude from the ends of the support frame 105.

On the other hand, when the flexible display unit 151 is bent such that the screen thereof faces to the outside as shown in FIG. 2(b), the ends of the support frame 105 located inside may protrude from the ends of the flexible display unit 151. To allow the two members to move in the width direction along the longitudinal bending direction, the flexible display unit 151 and the support frame 105 may need to be coupled to be movable within a predetermined range in the bending direction (first direction).

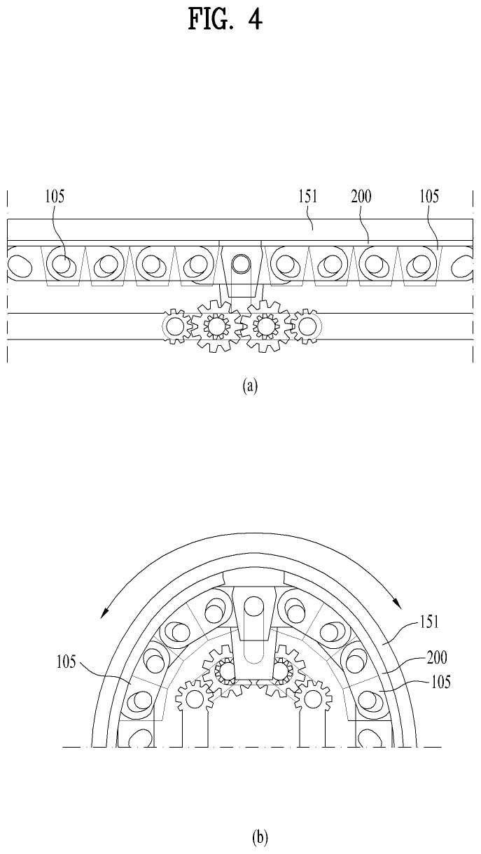

FIG. 4 is a view showing the flexible display unit 151 of the mobile terminal 100 and support structure thereof according to the present disclosure. As shown in FIG. 4(a), the support frame 105 for supporting the rear surface of the flexible display unit 151 may be made of a bendable material, but the support frame 105 may be implemented by connecting a plurality of unit frames so that the support frame 105 is bendable.

To implement a plurality of support frames 105, a bar-shaped unit frame extending in a second direction perpendicular to the first direction may be used. To this end, a connector for connecting adjacent unit frames may be included. The connector may adjust the angle between unit frames so that the support frames 105 may be bent as shown in FIG. 4(b).

The support frames 105 may not only secure the rigidity of the mobile terminal 100 based on a rigid member extending in the second direction but also be bent in the first direction, thereby implementing the foldable mobile terminal 100 equipped with the flexible display unit 151.

An adhesive tape 200 may be used to bond the support frames 105 and the flexible display unit 151. Since the adhesive tape 200 has elasticity, the length thereof is variable. Accordingly, the adhesive tape 200 may compensate for the tolerance between the flexible display unit 151 and the support frames 105, which occurs when the flexible display unit 151 and the support frames 105 are bent in the first direction.

In the embodiment shown in FIG. 3, since the bending part is located within the flexible display unit 151, there may be no length tolerance at the ends. In addition, since the position of the bending part is changed, the support frames 105 and the flexible display unit 151 need to be coupled to allow movement in the first direction

The flexible display unit 151 and the support frames 105 may be fastened by inserting a coupling protrusion into a rectangular coupling hole. However, in this case, the size of the product may increase and the reliability may decrease. Accordingly, the adhesive tape 200 having a variable shape within a predetermined range may be used.

That is, to compensate for the tolerance between the flexible display unit 151 and the support frames 105, an elastic material capable of being deformed laterally, particularly in the first direction may be used. The adhesive tape 200 may be partially omitted between the flexible display unit 151 and the support frames 105 to offset the tolerance for deformation.

However, the adhesive tape 200 has elasticity not only in the first direction but also in the thickness direction, so that when the user presses the flexible display unit 151 for a touch input, the adhesive tape 200 may not firmly support the rear surface of the flexible display unit 151, resulting in an input error. In addition, there is a problem that the flexible display unit 151 may be damaged if the mobile terminal 100 is dropped or stamped on the edge of a book in a bag.

To address the above-described issues, the present disclosure proposes to couple the flexible display unit 151 and the support frames 105 with the adhesive tape 200 capable of not only guaranteeing the elasticity in the first direction but also securing the rigidity in the thickness direction of the adhesive tape 200.

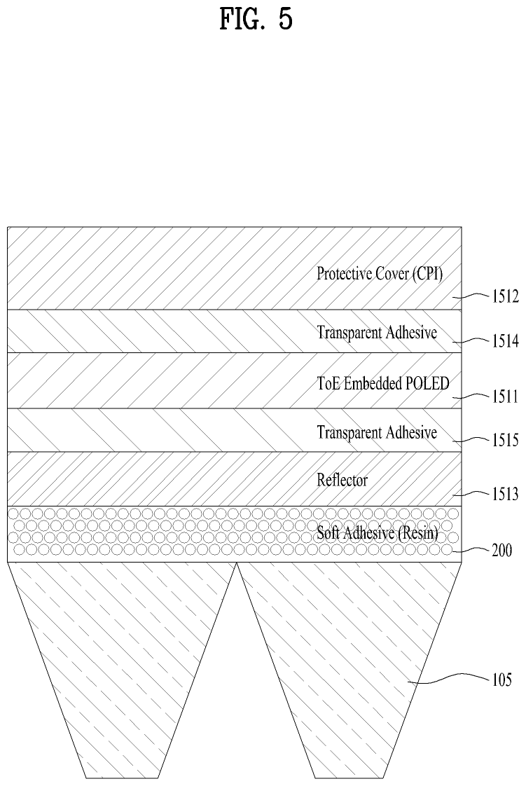

FIG. 5 is a view showing a layered structure of the flexible display unit 151 of the mobile terminal 100 according to the present disclosure. The flexible display unit 151 of the mobile terminal 100 according to the present disclosure may include a plastic organic light-emitting diode (POLED) 1511, a protective cover 1512, and a reflective layer 1513. The POLED 1511 may be covered by a plastic material rather than a glass layer to protect an organic light-emitting diode (OLED) so that the POLED 1511 is bendable. The OLED may emit light by itself based on a fluorescent organic compound. According to the layered structure, since no backlight is required, the thickness may be further reduced. The POLED may be integrated with the touch sensor. Alternatively, a separate touch sensor layer may be provided.

The protective cover 1512 may be further included to protect the front of the POLED 1511. The reflective layer may be provided on the rear surface of the POLED 1511 to increase visibility on the front surface. Transparent adhesives 1514 and 1515 may be used to attach the POLED 1511, the protective cover 1512, and the reflective layer 1513. The adhesive tape 200 for coupling the flexible display unit 151 having the layered structure and the support frames 105 positioned on the rear surface is provided.

According to the present disclosure, in addition to the adhesive tape 200 for coupling the flexible display unit 151 and the support frames 105, a glass fiber 201 may be further included. The glass fiber 201 may be obtained by drawing glass through a plurality of nozzles at high speed and then fiberizing the glass, and a single filament may be formed as fine as several μm in thickness.

The glass fiber 201 has high strength, and more particularly, high tensile strength in the longitudinal direction, and low wear resistance. That is, the rigidity of the adhesive tape 200 may be improved by mixing the glass fiber 201 with a binding resin 202, which is applied to a transparent film. The binding resin 202 may include at least one of epoxy, acrylic, silicone, urethane, and cyanate ester. The binding resin 202 has elasticity even after hardening, so that bending deformation and length deformation in the first direction may be allowed as described above.

However, the glass fiber 201 may be broken when bent in the longitudinal direction. Thus, if the glass fiber 201 is also arranged in the second direction perpendicular to the first direction in which the deformation occurs, the glass fiber 201 may not be broken in spite of the deformation in the first direction.

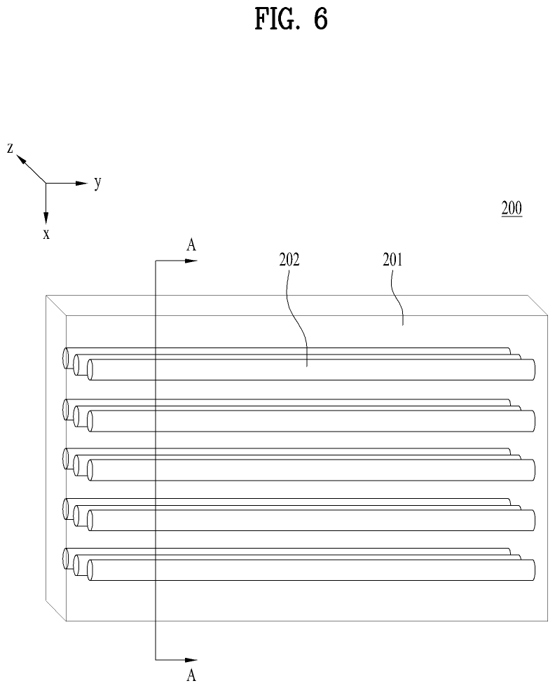

FIG. 6 is a view showing detailed configurations of the adhesive tape 200 according to the present disclosure. In FIG. 6, the x-axis is the first direction, the y-axis is the second direction, and the z-axis is the thickness direction of the mobile terminal 100. Since glass fibers 201 are staked in the adhesive tape 200 in the z-axis direction, the adhesive tape 200 having the glass fibers 201 staked therein may be more rigid than the adhesive tape 200 without the glass fibers 201 when a force is applied in the z-direction.

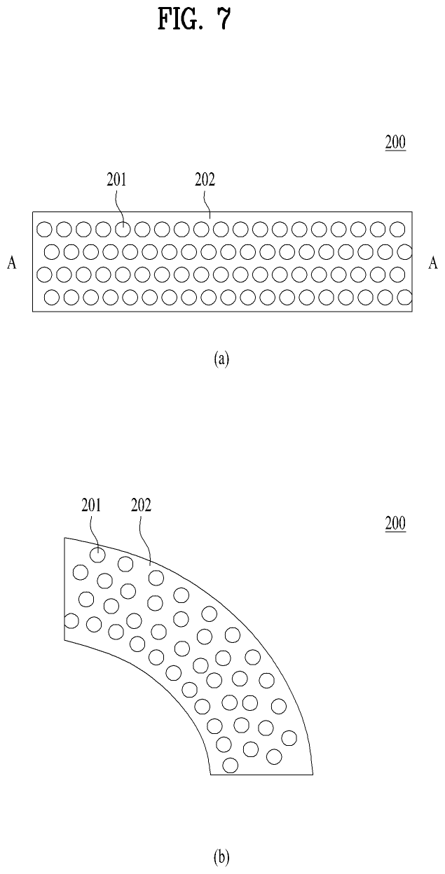

FIG. 7 is a cross-sectional view of the adhesive tape 200 of FIG. 6. Specifically, FIG. 7(a) shows the flat state, and FIG. 7(b) shows the curved state. Even if the adhesive tape 200 is bent in the first direction, no force is directly transmitted to the glass fibers 201, so that the glass fibers 201 may maintain the rigidity in the thickness direction without breaking.

The adhesive tape 200 including the glass fibers 201 may be used to couple two flexible members (first and second flexible members) as well as for the coupling between the flexible display unit 151 and the support frames 105. In this case, when the first and second flexible members are deformed in the first direction, the glass fibers 201 may maintain the rigidity with no damage.

The above-described embodiments are to be construed in all aspects as illustrative and not restrictive. The scope of the present disclosure should be determined by reasonable interpretation of the appended claims. In addition, the present disclosure covers the modifications and variations of this disclosure that come within the scope of the appended claims and their equivalents.

1. An adhesive tape, comprising:
a plurality of fibers; and
a binding resin having the plurality of fibers mixed therein,
wherein the fibers are arranged side by side in a first direction and elongate in a second direction perpendicular to the first direction.

2. The adhesive tape of claim 1, wherein the binding resin comprises at least one of epoxy, acrylic, silicone, urethane, or cyanate ester.

3. The adhesive tape of claim 1, wherein the adhesive tape has flexibility in the second direction.

4. A mobile terminal, comprising:
a first flexible member configured to bend in a first direction;
a second flexible member positioned on a rear surface of the first flexible member; and
an adhesive tape configured to attach the first flexible member and the second flexible member,
wherein the adhesive tape comprises:
a plurality of fibers arranged side by side in the first direction and elongate in a second direction perpendicular to the first direction; and
a binding resin having the plurality of fibers mixed therein.

5. The mobile terminal of claim 4, wherein the first flexible member comprises a flexible film, and
wherein the second flexible member comprises a plurality of unit frames and a connector configured to vary an angle between the unit frames.

6. The mobile terminal of claim 5, wherein the unit frames are arranged side by side in the first direction and have a bar shape extending in the second direction.

7. The mobile terminal of claim 5, wherein the first flexible member comprises a flexible display.

8. The mobile terminal of claim 4, wherein the binding resin comprises at least one of epoxy, acrylic, silicone, urethane, or cyanate ester.
